(19) United States
(12) Patent Application Publication
(10) Pub. No.: US 2007/0044355 A1
(43) Pub. Date: Mar. 1, 2007

(54) High-visibility airborne color LED display sign

(76) Inventors: Robert Daniel Shofner, Canton, OH (US); Robert Herman Peacock, Akron, OH (US); James Carlyle Maloney JR., North Canton, OH (US)

Correspondence Address: Howard M. Cohn, Suite 220, 21625 Chagrin Blvd., Cleveland, OH, 44122, US

(21) Appl. No.: 11/217,897

(22) Filed: Sep. 1, 2005

(51) Int. Cl. G09F 21/06

(52) U.S. Cl. 40/212

(57) ABSTRACT

A large-scale high-visibility, color LED display sign intended for viewing from a long distance is described wherein power is managed by dividing the display sign into two or more distinct sections and providing power to each section from a respective separate power source. As a result, the amount of current drawn from any one source is reduced, thereby reducing require conductor sizes, circuit breaker trip limits, etc. Additionally, in applications where two or more power sources are available, this permits the distribution of the power load from the sign across the multiple sources without requiring bulky, complex and expensive power sharing apparatus. The sign's computer interface electronics are operated (scanned) directly by bus-connected interface circuitry. This eliminates the need for an external image buffer memory, since the computer's local memory acts as an image buffer. The computer serially transmits pixel data to the display via the interface mechanism. The display data is held in shift registers that receive the serial data. When the data for any given section of the sign is completely shifted in, a strobe is generated to transfer the pixel data to the display. Because of the direct bus-connected nature and direct computer control of the scanning action of the sign's interface circuitry, considerable interface circuitry is eliminated and data transfer operations at the full speed of the computer system.

### TECHNICAL FIELD OF THE INVENTION

The present invention relates to large-scale electronic sign displays, more particularly to large-scale color LED displays, and still more particularly to color LED displays intended for airborne or long-distance deployment relative to the observer thereof.

### BACKGROUND

Over the last several decades, many types of matrix display signs have been developed for a wide variety of applications. With some of the more recent developments, some of these signs are even capable of displaying full color motion video. These signs are ubiquitous, appearing as flashing message boards on roadways, informational signs on buildings and in shop windows, on billboards, and even at ball parks and arenas.

A universal characteristic of matrix signs is that they are made up of a plurality of “pixels” or picture elements. These pixels are arranged in a two dimensional array and their optical characteristics (e.g., brightness or reflectivity) are individually controlled so that the overall appearance is that of a complete two-dimensional image. For large-scale signs, arrays of light emitting diodes (LEDs) have proven to be especially useful and effective. As solid-state devices, LEDs are particularly rugged and are relatively impervious to mechanical shock and vibration. They have very long life when properly used (especially when compared to incandescent bulbs, plasma displays, neon and other luminous devices), and are available in a variety of colors—most importantly red, green and blue, which makes them particularly well suited to constructing multi-color and full-color displays. LED drive circuits are easily adapted to span a wide range of pixel brightness (intensity), either by controlling the LED's forward current continuously, or via pulse width modulation of a fixed drive current.

Another advantage of LEDs in large scale displays is that large effective pixel sizes can be created by utilizing clusters of LEDs for each pixel. For example, a smaller color matrix display might employ one red-green-blue (RGB) trio of LEDs for each pixel, while a large display might use a larger number of LEDs per pixel to create a larger effective pixel size. (In fact, for smaller displays, tri-color RGB LED trios are available in a single standard-size LED package). The LEDs making up a pixel can be driven in series, in parallel or in series-parallel combinations, providing great flexibility in accommodating different power supply voltages and current drive levels.

One particularly unique class of matrix sign is airship signs, such as the types of signs often seen on the familiar Goodyear fleet of blimps. These displays present a number of special challenges rarely encountered in other applications. For one thing, the airship signs are deployed on a curved surface—the exterior of the blimp. As a result, the: pixels must be placed and aimed carefully to provide a natural and consistent appearance to the viewer on the ground. In addition, there are special challenges associated with mounting anything on an airship envelope, as the envelope must be maintained gas tight, the risk of puncture must be effectively eliminated and excessive interference with airflow around the envelope must be avoided.

Further, the viewing distances for airship signs are much greater than those encountered in most other matrix sign applications. Even billboard-mounted matrix signs and ballpark matrix signs are generally closer to the viewer than are airship signs. This means that airship signs, in order to be seen comfortably, need to have very wide pixel spacing and very high brightness compared to other signs of comparable resolution. However, due to the wide pixel spacing, if the pixel size is too small on the airship envelope, each pixel will appear to the viewer as a very tiny, very bright point and will not integrate as well into the appearance of a continuous image as a larger, more “diffuse” pixel would.

In airborne applications, especially in lighter-than-air craft such as blimps, payload weight is always a concern. As a result, it is not feasible to carry huge battery racks, generators or lots of bulky electronic equipment. The weight of the sign itself must be considered. This presents another challenge for airborne sign applications. Because of the need for high brightness, the airborne sign can draw a great deal of power especially when providing full-color motion video. If the sign were merely flashing black-and-white bi-level images and logos, most of the pixels would be completely dark at any given time. With continuous-tone video, however, especially when there is a bright background, many or all of the pixels may be fully or partly illuminated for extended periods of time, creating a very high current draw as compared to simple text and bi-level image display.

In video applications, “continuous tone” control of brightness and high frame rates (>30 fps) are required to provide smooth, visually appealing, realistic motion video. In order to be completely compatible with commercial television standards, the system must be capable of updating whole images 30 times per second or more. This requires very high data bandwidth from the video source out to the display's pixels.

Typically, display sign images are maintained in a display buffer memory. A scanning mechanism rapidly and repeatedly scans through the display memory and updates pixel intensities according to the values stored in the buffer memory. Assuming that the scanning mechanism is fast enough, this produces the appearance of a relatively flicker-free two-dimensional image. For motion video, however, not only must the data be scanned out of the display buffer memory at a rapid rate, but the contents of the display buffer memory must be constantly updated with new image data. A mechanism is required that can translate video image data from the video source into the format required in the display buffer memory in real-time. The rate at which this memory can be updated places limitations on how fast images can be updated on the display. Since the buffer memory needs to be accessed by both the mechanism that stores image data into it and by the mechanism that scans data out of it, either dual-port memory techniques must be employed or other memory sharing mechanisms must be provided to coordinate and synchronize data traffic in and out of the buffer memory. Since the buffer memory is typically embedded in a display controller acting as a remote peripheral device to a computer or other device acting as a video source, the mechanism by which data is transferred into the buffer memory can present a significant bottleneck.

### SUMMARY OF THE INVENTION

The present inventive technique helps to manage power effectively by dividing a display sign into two or more distinct sections and providing power to each section from a separate power source. As a result, the amount of current drawn from any one source is reduced, thereby reducing require conductor sizes, circuit breaker trip limits, etc. Additionally, in applications where two or more power sources are available, this permits the distribution of the power load from the sign across the multiple sources without requiring bulky, complex and expensive power sharing apparatus.

This is particularly advantageous in airship-based sign applications (e.g., the familiar Goodyear blimp) wherein a full-color LED sign display is mounted on the envelope (outer skin) of a lighter-than-air craft (blimp). The blimp has two aircraft engines that generate a limited amount of power. This power is available for powering the sign, but also powers all other on board avionics and electronics. By permitting the power load to be distributed across the two engines, more power is available to the sign without placing an extremely large load on either engine's power generating apparatus.

According to an aspect of the invention, the sign's computer interface electronics are designed to be operated (scanned) directly by bus-connected interface circuitry. This eliminates the need for an external image buffer memory, since the computer's local memory acts as an image buffer. The computer serially transmits pixel data to the display via the interface mechanism. The display data is held in shift registers that receive the serial data. When the data for any given section of the sign is completely shifted in, a strobe is generated to transfer the pixel data to the display. Because of the direct bus-connected nature and direct computer control of the scanning action of the sign's interface circuitry, considerable interface circuitry is eliminated and data transfer operations at the full speed of the computer system.

### BRIEF DESCRIPTION OF THE DRAWINGS

Reference will be made in detail to preferred embodiments of the invention, examples of which are illustrated in the accompanying drawing figures. The figures are intended to be illustrative, not limiting. Although the invention is generally described in the context of these preferred embodiments, it should be understood that it is not intended to limit the spirit and scope of the invention to these particular embodiments.

Certain elements within selected drawings may be illustrated not-to-scale, for illustrative clarity. The cross-sectional views, if any, presented herein may be in the form of “slices”, or “near-sighted” cross-sectional views, omitting certain background lines which would otherwise be visible in a true cross-sectional view, for illustrative clarity.

The structure, operation, and advantages of the present preferred embodiment of the invention will become further apparent upon consideration of the following description taken in conjunction with the accompanying drawings, wherein:

FIG. 1 is a block diagram of a matrix sign display divided into two distinct sections, in accordance with the invention.

FIG. 2 is a block diagram of a representative panel of a matrix sign display, in accordance with the invention.

FIG. 3A is a view of a typical LED pixel board for a matrix sign display, in accordance with the invention.

FIG. 3B is a block diagram of a typical LED pixel board for a matrix sign display, in accordance with the invention.

FIG. 4 is a block diagram of a computer interface for a matrix sign display, in accordance with the invention.

FIG. 5 is a block diagram of a matrix sign display system, in accordance with the invention.

### DETAILED DESCRIPTION OF THE INVENTION

The discussion hereinbelow is directed to a specific airship-based sign application wherein a full-color LED sign display is mounted on the envelope (outer skin) of a lighter-than-air craft (blimp). The sign is divided into eight logical panels, each comprising 480 LED pixel boards arranged on a grid 16 positions wide by 60 positions high. The LED pixel boards are arranged in an interleaved checkerboard pattern, with alternating positions empty. In effect, then, each vertical column of each panel comprises 30 LED pixel boards, and the panel can be considered to be organized logically as a 16 by 30 array of LED boards. Each logical panel has dedicated circuitry associated with it. In all, there are 128 horizontal positions and 60 vertical positions, with only half of the positions populated. (In one preferred application, two end columns are not populated with LED pixel boards, providing a display with only 126 horizontal positions). The airship (blimp) on which the display is mounted has two aircraft engines powering it. In addition to providing propulsion for the airship, each engine generates 28-volt DC power that can be used to power the sign display.

The airship display described herein has two modes of operation: a day mode and a night mode. In the day mode, a large number of high-intensity LEDs are used in a simple bi-level “on-off” mode of operation to provide bright animated text and logo displays. At night however, red, green and blue triads of LEDs are employed to display full-color “photographic” images and video. The night display mode is not effective during daylight hours since the ambient light and the colors on the envelope of the airship prevent display of a viable “black” background when pixels are not illuminated, thereby providing extremely poor image contrast. The day mode display has fewer pixels than the night mode display, so only some of the LED pixel boards are populated with day mode LEDs and driver circuitry.

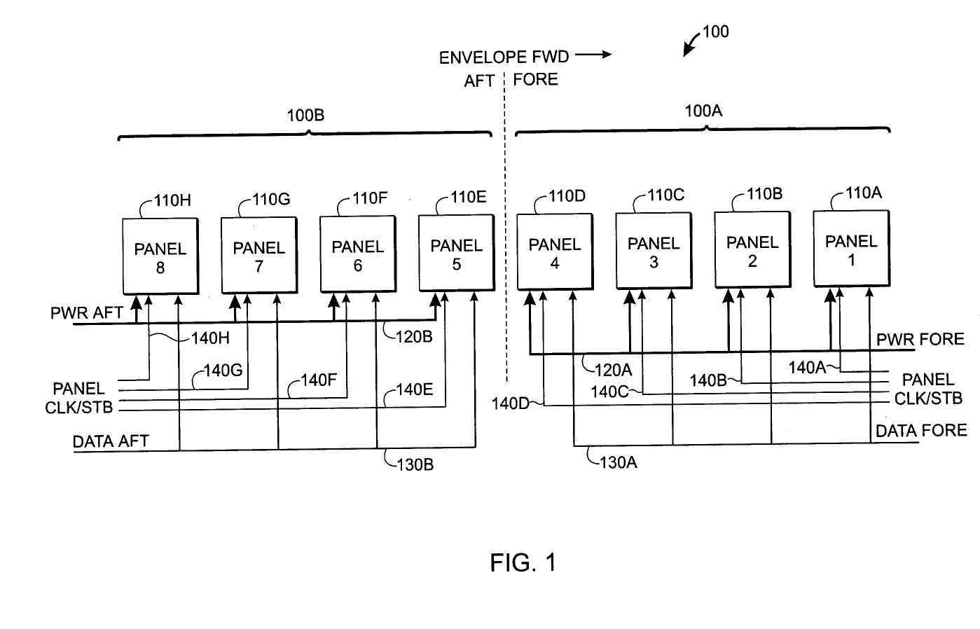

Those of ordinary skill in the art will immediately understand that the techniques hereinbelow have broader applicability than the specific airship application shown and described with respect to FIGS. 1-5, and that the present inventive techniques are readily adapted to land-based sign applications with differing numbers of power sources.

The present inventive technique provides improved power distribution in an LED matrix display sign by dividing the sign into two distinct sections, each section powered separately by a corresponding power source. This reduces the total amount of current required from either power source, and is particularly advantageous when two power sources are available (such as power generated separately by each of two aircraft engines), because the power from both sources can be utilized without having to combine them into a single source. If the sign were powered by only a single power source, then it would either be necessary to limit the sign's power usage to the power available from one of the power sources alone, or to combine the two sources into a single higher capacity source using a high-power load sharing mechanism. Such mechanisms can be bulky and expensive.

Further, the present inventive technique eliminates a significant bottleneck in communicating with a matrix sign display by providing a computer with a direct, bus-connected interface to the display. In effect, the computers own local memory is used as the display buffer. This has the net effect of simultaneously reducing the complexity and bulk of sign display's support circuitry and of speeding up the process of writing to the sign by allowing the computer to communicate with the sign's computer interface at its full bus speed.

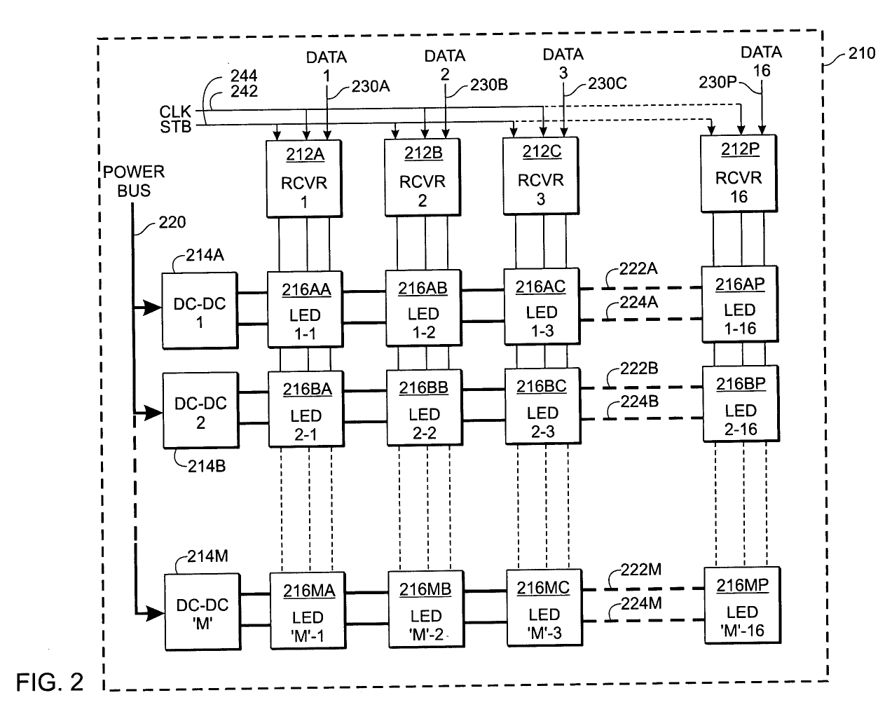

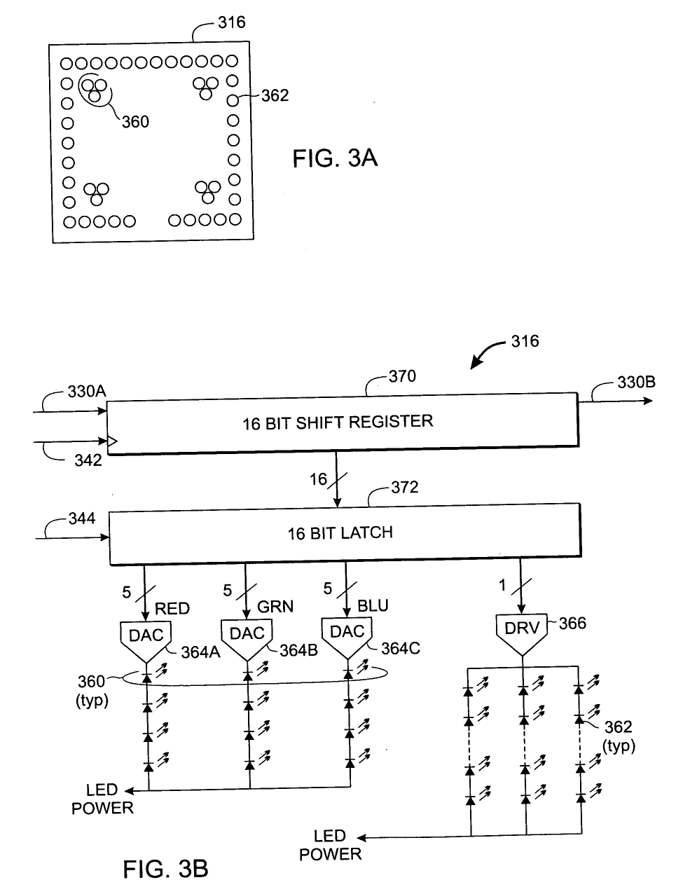

FIG. 1 is a block diagram of a matrix sign display 100 which has been divided into two sections, a “fore” section 100A and an “aft” section 100B. The display 100 comprises eight panels, 110A, 110B, 110C, 110D, 110E, 110F, 110G and 110H, listed in order from front (fore) to back (aft). The “fore” section 100A comprises the four frontmost panels 110A, 110B, 110C and 110D. The “aft” section 100B comprises the four rearmost panels 110E, 10F, 10G and 110H. The panels 110A-D of the fore section 100A (PWR FORE) are powered by a first power source 120A, and the panels 110E-H of the aft section 100B are powered by a second power source 120B (PWR AFT). Each of the panels 110A-H receives its own respective clock and strobe signal. In the figure, panel clock/strobe signals 140A-H are indicated by single lines, but represent pairs of signals: a clock signal and a strobe signal. This is described in greater detail herein below with respect to FIGS. 2 and 3B. Data 130A for the fore section 100A of the sign display 100 is provided in common to the four fore section panels 110A-D. Similarly, data 130B for the aft section 100B of the sign display 100 is provided in common to the four aft section panels 110E-H.

Those of ordinary skill in the art will immediately understand that it is possible to divide a sign display into more than two sign sections for powering by a like number of power sources and that the sign display 100 of FIG. 1 is a two-section example of this technique. It is fully within the spirit and scope of the present invention to divide into more than two sections, using the same basic strategy.

FIG. 2 is a block diagram of a representative panel 210 (compare 110A-H, FIG. 1) of a matrix sign display system. The panel 210 comprises an array of LED pixel boards 216AA-MP arranged in a 16 column×30 row logical array. (12 representative pixel boards of the 16×30 logical array are shown in the Figure). Each of the 16 columns has a receiver 212A-P associated therewith. Each of the 30 rows has a DC-DC converter 214A-M associated therewith. Each receiver 212A-P receives a respective data bit signal 230A-P, which it buffers and provides to all of the LED pixel boards in the column with which the receiver 212A-P is associated. The data path through the LED pixel boards 216AA-MP in any given column is “daisy-chained”, i.e., each LED pixel board has a “data in” and a “data out” signal. The data out signal of each LED pixel board 216AA-MP is connected to the data in signal of the next sequential LED pixel board in the same column. The receivers 212A-P all receive a panel clock signal 242 and a panel strobe signal 244 in common, and buffer these signals for distribution to the LED pixel boards 216AA-216MP in their respective columns.

Each DC-DC converter 214A-M converts 28V “bulk” power from a power distribution bus 220 and converts it to 5V logic power and 15V LED power. This power is then provided in parallel to each of the LED pixel boards 216AA-MP in the row with which the DC-DC converter is associated. By using a plurality of DC-DC converters for each logical panel 210, power efficiency is maximized and the amount of power that must be supplied by any one converter 214‘x’ and the amount of local power dissipation by those converters are kept at manageable levels. This simplifies the DC-DC converter circuitry greatly, permitting the use of inexpensive, standard components.

Those of ordinary skill in the art will immediately understand that the number of DC-DC converters and the manner in which power is distributed to individual LED pixel boards can be determined on an application-dependent basis. It is not necessary to limit the number of DC-DC converters to one per row per panel. It is also not necessary to provide one converter per row per panel.

FIG. 3A is a view of a representative LED pixel board 316 (compare 216AA-MP, FIG. 2) for the LED matrix sign display described hereinabove with respect to FIGS. 1 and 2. The LED pixel board 316 comprises four “night mode” RGB triads 360 (one representative triad indicated in the figure), and a plurality of high-intensity “day mode” LEDs 362 arranged around the perimeter of the pixel board 316 (one representative “day mode” LED 362 indicated in the figure). On a pixel board intended for night mode only, the “day mode” LEDs 362 and any associated drive circuitry can be omitted.

FIG. 3B is a block diagram of circuitry associated with a typical LED pixel board 316. A 16 bit shift register 370 receives a data bit input 330A (compare 230A-P, FIG. 2) and a clock signal 342 (compare 242). Each time the clock signal 342 is pulsed, a bit is shifted into the shift register 370. Each pulse of the clock signal 342 shifts in a new data bit value, moving the previously shifted bit into a next position in the register, ultimately appearing at a serial data output 330B of the shift register after 16 pulses. The 16 bit contents of the shift register 370 are presented at an input of a 16 bit latch 372. The latch 372 receives a strobe signal 344. When a transfer pulse occurs on the strobe signal the latch 372 transfers data from its 16 inputs to its 16 outputs. As shown in the figure, five of the output bits are connected to an input of a first DAC (digital to analog converter) 364A, another five of the output bits are connected to an input of a second DAC 364B, another five of the output bits are connected to an input of a third DAC 364C, and one output bit is connected to a “day mode” LED driver 366.

When the bit connected to the day mode driver 366 is in an “on” state, the day mode driver energizes and illuminates the day mode LEDs 362 on the pixel board 316.

The first DAC 364A controls the illumination of red LEDs in the RGB triads 360, according to the 5 bit value at its input. The second DAC 364B controls the illumination of green LEDs in the RGB triads 360, according to the 5 bit value at its input. The third DAC 364C controls the illumination of blue LEDs in the RGB triads 360, according to the 5 bit value at its input. Each DAC can drive its associated color LEDs to any of 32 distinct intensity levels.

Those of ordinary skill in the art will immediately understand that the block diagram of FIG. 3B is highly schematic in nature and that there are many different possible ways of accomplishing this multi-intensity drive scheme. For example, the DACs 364B can accomplish their function by varying continuous LED current or by means of pulse width modulation. It is within the spirit and scope of the present inventive technique to use any suitable means to control LED intensity.

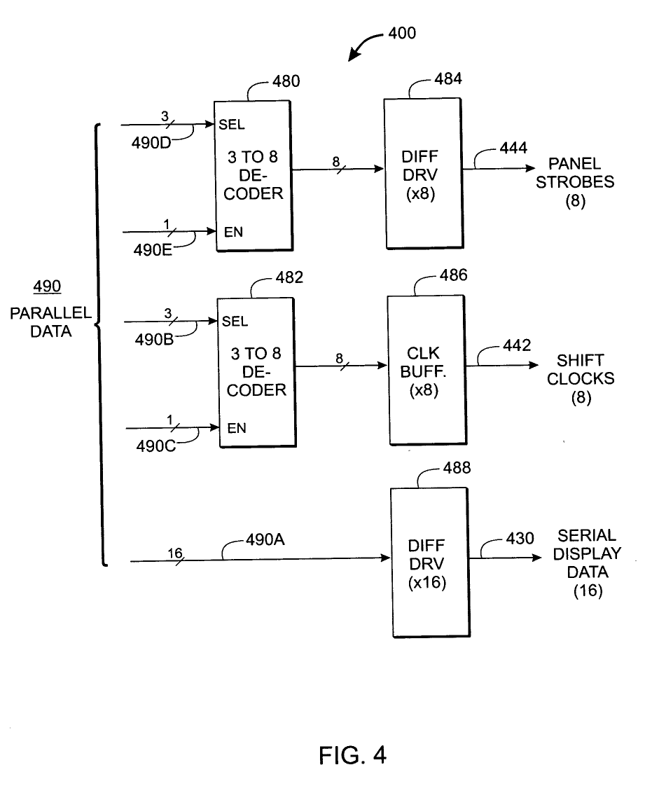

FIG. 4 is a block diagram of a computer interface 400 for the matrix sign display system described hereinabove. 24-bit parallel data 490 is received from a computer output register. A 16-bit portion 490A of the parallel data 490 is buffered by differential drivers 488 to provide serial display data 430 for transmission to the 8 logical display panels. (Although FIG. 1 shows the data for the “fore” section 100A and aft section 100B of the sign display 100 as having separate data signals 130A and 130B, they are commonly connected in this application). One bit 490C of the parallel data 490 is used as an enable to a 3-to-8 decoder 482, and three bits 490B of the parallel data 490 are used as selector inputs to the decoder 482. Eight output lines from the decoder are buffered by clock buffers 486 and are presented to the logical panels as shift clocks. By identifying a logical panel number with the three selector bits 490B and by pulsing the associated enable bit 490C, a shift clock pulse is transmitted to the identified logical panel (see FIGS. 2 and 3B), shifting the 16 bit serial display data 430, with one serial data bit applied to each of the columns of the logical panel. Similarly, one bit 490E of the parallel data 490E is used and an enable input to another 3-to-8 decoder 480 and three bits 490D of the parallel data 490 are used as selector bits. Eight output lines from the 3-to-8 decoder 480 are buffered by differential drivers 484 and presented to the eight logical panels as panel strobes. By identifying a logical panel on the selector bits 490D and pulsing the enable bit 490E, a strobe pulse is transmitted to the identified panel, transferring shifted data from pixel shift registers to the pixel latch for display (see FIGS. 2 and 3B).

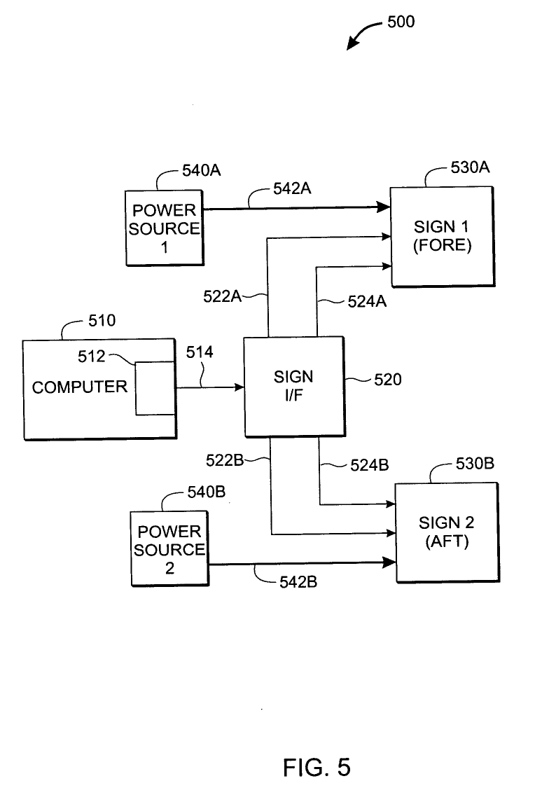

FIG. 5 is a block diagram of a matrix sign display system 500 of the type described hereinabove, wherein a computer 510 having a bus-connected parallel output register 512 connects to a sign interface 520 (compare 400) to control two sign sections 530A and 530B (compare 100A, 100B). The sign interface 520 buffers and provides serial display data 526 (compare 430) to the two sign sections 530A and 530B. It also buffers clock signals 522A and buffered strobe signals 524A to the first sign section 530A, and buffered clock signals 522B and buffered strobe signals 524B to the second sign section 530B. A first power source 540A (e.g., generator, battery, etc.) powers the first sign section 530A via a first power bus 542A. A second power source 540B powers the second sign section 530B via a second power bus 542B.

To control the display system, the computer builds frame images to be displayed, then directly accesses the display via the interface mechanism described hereinabove with respect to FIG. 4. The panel must be analyzed for bit position and organized onto the data bus according to the arrangement of pixels in the display and the desired intensity value(s), then shifted into the appropriate pixels by identifying panels and generating panel clock signals. For each panel, 480 shifts are required, since there are 30 pixels in each column, and 16 bits of pixel data associated with each pixel. Shifted-in data is transferred from the shift registers to the display by generating panel strobes in the manner described above.

Panel data, clocks and strobes can be generated under direct program control, or the pattern of data, clocks and strobes can be pre-formulated into a memory buffer and transferred to the display using a timer-driven DMA (direct memory access scheme). In either case, the interface delay is minimal in this scheme due to the direct bus-connected nature of the sign interface. Further, interface circuitry is minimized by eliminating a separate display memory and sign scanner function and allowing the computer to provide these functions directly by using its own memory for display image storage and by generating the scanning clock and strobe signals under program (and/or DMA) control. Although the invention has been shown and described with respect to a certain preferred embodiment or embodiments, certain equivalent alterations and modifications will occur to others skilled in the art upon the reading and understanding of this specification and the annexed drawings. In particular regard to the various functions performed by the above described components (assemblies, devices, circuits, etc.) the terms (including a reference to a “means”) used to describe such components are intended to correspond, unless otherwise indicated, to any component which performs the specified function of the described component (i.e., that is functionally equivalent), even though not structurally equivalent to the disclosed structure which performs the function in the herein illustrated exemplary embodiments of the invention. In addition, while a particular feature of the invention may have been disclosed with respect to only one of several embodiments, such feature may be combined with one or more features of the other embodiments as may be desired and advantageous for any given or particular application.

What is claimed is:

1. A high-visibility color LED display sign, comprising:
two or more sign sections, with each sign section being powered independently by a separate power source, each sign section further comprising one or more logical panels, each logical panel further comprising a plurality of LED pixels organized into a two-dimensional array;
means for providing display data serially to each of the logical panels; and
means associated with each LED pixel for controlling the intensity thereof.

2. A high-visibility color LED display sign according to claim 1, further comprising:
interface means for adapting a computer system to directly control transfer of serial display data into the logical panels.

3. A high-visibility color LED display sign according to claim 2, wherein the interface means connect to a bus-connected register in the computer system.

4. A high-visibility color LED display sign according to claim 1, wherein the sign is attached to an exterior envelope of a lighter-than-air craft.

5. A high-visibility color LED display sign according to claim 4, wherein there are two sign sections.

6. A high-visibility color LED display sign according to claim 5, wherein:
the lighter-than-air craft has two engines;
each engine has power generating means associated therewith; and
the two sections of the sign are each powered by the power generating means associated with a respective engines.

7. A high-visibility color LED display sign, comprising:
two or more sign sections, each sign section further comprising one or more logical panels, each logical panel further comprising a plurality of LED pixels organized into a two-dimensional array;
means for providing display data serially to each of the logical panels;
means associated with each LED pixel for controlling the intensity thereof; and
interface means for adapting a computer system to directly control transfer of serial display data into the logical panels.

8. A high-visibility color LED display sign according to claim 7, wherein the interface means connect to a bus-connected register in the computer system.

9. A high-visibility color LED display sign according to claim 1, wherein the sign is attached to an exterior envelope of a lighter-than-air craft.

10. A high-visibility color LED display sign according to claim 9, wherein:
each sign section is independently powered by a separate power source.

11. A high-visibility color LED display sign according to claim 4, wherein there are two sign sections.

12. A high-visibility color LED display sign according to claim 5, wherein:
the lighter-than-air craft has two engines;
each engine has power generating means associated therewith; and
the two sections of the sign are each powered by the power generating means associated with a respective engine.
